(19) United States
(12) Patent Application Publication
(10) Pub. No.: US 2016/0259788 A1
(43) Pub. Date: Sep. 8, 2016

(54) MEDIA TRACK ORGANIZING SYSTEM AND METHOD THEREFORE

(71) Applicants: Jason Kerry Jamieson, Pyrmont (AU); Shruti Manubhai Patel, Clontarf (AU)

(72) Inventor: Jason Kerry Jamieson, Pyrmont (AU)

(21) Appl. No.: 15/061,153

(22) Filed: Mar. 4, 2016

(30) Foreign Application Priority Data
Mar. 5, 2015 (AU) 2015900763

(51) Int. Cl. G06F 17/30

(52) U.S. Cl. CPC G06F 17/30044; G06F 17/30843; G06F 17/30772; G06F 17/30752; G06F 17/3082; G06F 17/30056; G06F 17/3002

(57) ABSTRACT

The present invention relates to a system and method for automated pre-editing of a series of media clips, including video and audio clips to produce a pre-edited file conveniently and quickly that can be used for subsequent editing.

### FIELD OF THE INVENTION

The present invention relates to a media track organizing system and in particular to a track organizing system for use in organizing several media tracks or streams before editing.

The invention has been developed primarily for use in/with video and sound editing and will be described hereinafter with reference to this application. However, it will be appreciated that the invention is not limited to this particular field of use.

### BACKGROUND OF THE INVENTION

Presently, pre-produced (i.e. not live) media content is recorded as tracks of video and/or audio. The various tracks are then retrieved as an output digital file by assistant editors, who manually pre-edit the sequence by synchronizing the clips chronologically on various video and audio tracks.. The ordered tracks are then exported again as an AAF file for typical use by editors on AVID media composer software for final editing.

Where multiple video and/or audio streams have been used, this pre-editing process may be tedious and time-consuming.

Any discussion of the background art throughout the specification should in no way be considered as an admission that such background art is prior art, nor that such background art is widely known or forms part of the common general knowledge in the field in Australia or any other country.

### SUMMARY OF THE INVENTION

The invention seeks to provide a track organizing system and method therefore which will overcome or substantially ameliorate at least some of the deficiencies of the prior art, or to at least provide an alternative.

According to a first aspect of the present invention, a media track organizing system is provided for organizing media tracks that have been previously recorded, the track organizing system comprising
a. computer readable storage medium configured for storing instructions for
   i. receiving information indicative of a plurality of media tracks, each media track comprising one or more media clips, each media clip extending over a given time range;
   ii. determining a series of groups from the plurality of media tracks, wherein each group is defined by a series of media clips extending over a timeframe, wherein at least part of the timeframe of each media clip in that group overlaps at least part of the timeframe of every other media clip in that group by at least one frame.

In one embodiment, the media clips are one or more selected from video clips and audio clips.

In one embodiment, the computer readable storage medium is configured for storing instructions for
a. separating at least one or more video clip into grouped video clips according to the timeframe of the determined series of groups.

In one embodiment, the computer readable storage medium is configured for storing instructions for
a. allocating the grouped video clips to a group in a digital file.

In one embodiment, the computer readable storage medium is configured for storing instructions for
a. receiving at least one or more audio tracks associated with a received video track, each track comprising one or more audio clips.

In one embodiment, the computer readable storage medium is configured for storing instructions for
a. separating at least one or more audio clip into grouped audio clips according to the timeframe of the determined series of groups.

In one embodiment, the computer readable storage medium is configured for storing instructions for
a. allocating the grouped audio clips to a group in a digital file.

In one embodiment, the computer readable storage medium is configured for storing instructions for
a. receiving at least one or more external audio tracks comprising external audio clips not recorded in association with a video clip; and
b. separating the at least one or more external audio clips into grouped external audio clips according to the timeframe of the determined series of groups.

In one embodiment, the computer readable storage medium is configured for storing instructions for
a. allocating the grouped external audio clips to a group in a digital file.

In one embodiment, the computer readable storage medium is configured for storing instructions for
a. transmitting the digital file.

In one embodiment, the computer readable storage medium is configured for storing instructions for
a. allocating a group identifier as a current group.

In one embodiment, the computer readable storage medium is configured for storing instructions for
a. determining whether the start timecode of a media clip overlaps by at least one frame with every other media clip in the current group.

In one embodiment, the computer readable storage medium is configured for storing instructions for
a. creating a new group based on the determination of whether the start timecode of a media clip overlaps by at least one frame with every other media clip in the current group.

In one embodiment, the computer readable storage medium is configured for storing instructions for
a. allocating portions of media clips to groups based on whether the time range of the media clips overlaps the start timecode of the new group.

In one embodiment, the computer readable storage medium is configured for storing instructions for
a. receiving an instruction to crop media clips in an allocated group to limit their time range between the latest start timecode of any video clip in the group and the earliest end timecode of any video clip in the group.

In one embodiment, the computer readable storage medium is configured for storing instructions for
a. cropping media clips in an allocated group to limit their time range between the latest start timecode of any video clip in the group and the earliest end timecode of any video clip in the group.

In one embodiment, the computer readable storage medium is configured for storing instructions for
a. receiving an instruction to crop audio clips in an allocated group to limit their time range between the earliest start timecode of any video clip in the group and the latest end timecode of any video clip in the group.

In one embodiment, the computer readable storage medium is configured for storing instructions for
a. cropping audio clips in an allocated group to limit their time range between the earliest start timecode of any video clip in the group and the latest end timecode of any video clip in the group.

In one embodiment, the computer readable storage medium is configured for storing instructions for
a. receiving an instruction to consolidate identified groups into a single multigroup by laying consecutive groups immediately after each other in digital output file, irrespective of the existence of time lapses between the end of one group and the start of the next group.

In one embodiment, the computer readable storage medium is configured for storing instructions for
a. consolidating identified groups into a single multigroup by laying consecutive groups immediately after each other in digital output file, irrespective of the existence of time lapses between the end of one group and the start of the next group.

In one embodiment, the computer readable storage medium is configured for storing instructions for
a. receiving preference information indicative of the preference, ranking, and/or weighting pre-allocated to a media clip.

In one embodiment, the computer readable storage medium is configured for storing instructions for
a. receiving an instruction to order media clips in their determined groups according to received preference information.

In one embodiment, the computer readable storage medium is configured for storing instructions for
a. ordering media clips in their determined groups according to the received preference information.

According to a second aspect of the present invention, a method of organizing media tracks on an electronic device is provided, the method of organizing media tracks comprising the steps of
i. receiving information indicative of a plurality of media tracks, each track comprising one or more media clips, each media clip extending over a given time range;
ii. determining a series of groups from the plurality of media, wherein each group is defined by a series of media clips extending over a timeframe, wherein at least part of the timeframe of each media clip in that group overlaps at least part of the timeframe of every other media clip in that group by at least one frame.

In one embodiment, the media clips are one or more selected from video clips and audio clips.

In one embodiment, the method comprises the step of
a. separating at least one or more video clip into grouped video clips according to the timeframe of the determined series of groups.

In one embodiment, the method comprises the step of
a. allocating the grouped video clips to a group in a digital file.

In one embodiment, the method comprises the step of
a. receiving at least one or more audio tracks associated with a received video track, each track comprising one or more audio clips.

In one embodiment, the method comprises the step of
a. separating at least one or more audio clip into grouped audio clips according to the timeframe of the determined series of groups.

In one embodiment, the method comprises the step of
a. allocating the grouped audio clips to a group in a digital file.

In one embodiment, the method comprises the step of
a. receiving at least one or more external audio tracks comprising external audio clips not recorded in association with a video track; and

b. separating the at least one or more external audio clips into grouped external audio clips according to the timeframe of the determined series of groups.

In one embodiment, the method comprises the step of
a. allocating the grouped external audio clips to a group in a digital file.

In one embodiment, the method comprises the step of
a. transmitting the digital file.

In one embodiment, the method comprises the step of
a. allocating a group identifier as a current group.

In one embodiment, the method comprises the step of
a. determining whether the start timecode of a media clip overlaps by at least one frame with every other media clip in the current group.

In one embodiment, the method comprises the step of
a. creating a new group based on the determination of whether the start timecode of a media clip overlaps by at least one frame with every other media clip in the current group.

In one embodiment, the method comprises the step of
a. allocating portions of media clips to groups based on whether the time range of the media clips overlaps the start timecode of the new group.

In one embodiment, the method comprises the step of
a. receiving an instruction to crop media clips in an allocated group to limit their time range between the latest start timecode of any video clip in the group and the earliest end timecode of any video clip in the group.

In one embodiment, the method comprises the step of
a. cropping media clips in an allocated group to limit their time range between the latest start timecode of any video clip in the group and the earliest end timecode of any video clip in the group.

In one embodiment, the method comprises the step of
a. receiving an instruction to crop audio clips in an allocated group to limit their time range between the earliest start timecode of any video clip in the group and the latest end timecode of any video clip in the group.

In one embodiment, the method comprises the step of
a. cropping audio clips in an allocated group to limit their time range between the earliest start timecode of any video clip in the group and the latest end timecode of any video clip in the group.

In one embodiment, the method comprises the step of
a. receiving an instruction to consolidate identified groups into a single multigroup by laying consecutive groups immediately after each other in digital output file, irrespective of the existence of time lapses between the end of one group and the start of the next group.

In one embodiment, the method comprises the step of
a. consolidating identified groups into a single multigroup by laying consecutive groups immediately after each other in digital output file, irrespective of the existence of time lapses between the end of one group and the start of the next group.

In one embodiment, the method comprises the step of
a. receiving preference information indicative of the preference, ranking, and/or weighting of a media clip.

In one embodiment, the method comprises the step of
a. receiving an instruction to order media clips in their determined groups according to received preference information.

In one embodiment, the method comprises the step of
a. ordering media clips in their determined groups according to the received preference information.

According to another aspect of the present invention, a media track organizing system is provided for organizing media tracks that have been previously recorded, the track organizing system comprising
a. a receiver configured for receiving information relating to one or more selected from audio and visual tracks;
b. a transmitter configured for transmitting information relating to audio and visual tracks;
c. a processor configured for operating according to digital instructions;
d. computer readable storage medium configured for storing instructions for:
   i. receiving information indicative of a plurality of media tracks, each track comprising one or more media clips;
   ii. determining the chronological sequence of a start of each media clip in each media track and an end of each media clip in each media track;
   iii. allocating a new group identifier to the chronological time span from the start of the new media clip if the start of a new media clip in a media track is immediately preceded by an end of a media clip in the chronological sequence, to thereby determine a series of groups.

In one embodiment, the media clips are one or more selected from video clips and audio clips.

In one embodiment, the computer readable storage medium is configured for storing instructions for
a. determining whether the start of a new media clip in a track is immediately preceded by an end of a clip in the chronological sequence.

In one embodiment, the computer readable storage medium is configured for storing instructions for
a. allocating a media clip Start Event to the start of each media clip in each media track.

In one embodiment, the computer readable storage medium is configured for storing instructions for
a. allocating a media clip End Event to the end of each media clip in each media track.

In one embodiment, the computer readable storage medium is configured for storing instructions for
a. determining the chronological sequence of the Start Events and the End Events.

In one embodiment, the computer readable storage medium is configured for storing instructions for
a. logging the chronological sequence of each of the Start Events and the End Events.

In one embodiment, the computer readable storage medium is configured for storing instructions for
a. allocating an initial group identifier.

In one embodiment, the group identifier is a number.

In one embodiment, the computer readable storage medium is configured for storing instructions for
a. separating at least one or more media clip into grouped media clips according to the timeframe of the determined series of groups.

In one embodiment, the computer readable storage medium is configured for storing instructions for
a. allocating the grouped media clips to a group in a digital file.

In one embodiment, the computer readable storage medium is configured for storing instructions for
a. receiving at least one or more audio tracks associated with a received video track, each track comprising one or more audio clips.

In one embodiment, the computer readable storage medium is configured for storing instructions for
a. separating at least one or more audio clip into grouped audio clips according to the timeframe of the determined series of groups.

In one embodiment, the computer readable storage medium is configured for storing instructions for
a. allocating the grouped audio clips to a group in a digital file.

In one embodiment, the computer readable storage medium is configured for storing instructions for
a. receiving at least one or more external audio tracks comprising external audio clips not recorded in association with a video track; and
b. separating the at least one or more external audio clips into grouped external audio clips according to the timeframe of the determined series of groups.

In one embodiment, the computer readable storage medium is configured for storing instructions for
a. allocating the grouped external audio clips to a group in a digital file.

According to a further aspect of the present invention, a method of organizing media tracks on an electronic device is provided, the method of organizing media tracks comprising the steps of
i. receiving information indicative of a plurality of media tracks, each track comprising one or more media clips;
ii. determining the chronological sequence of a start of each media clip in each media track and an end of each media clip in each media track;
iii. allocating a new group identifier to the chronological time span from the start of the new media clip if the start of a new media clip in a video track is immediately preceded by an end of a media clip in the chronological sequence, to thereby determine a series of groups.

In one embodiment, the media clips are one or more selected from video clips and audio clips.

In one embodiment, the method comprises the step of
a. determining whether the start timecode of a new media clip in a track is immediately preceded by an end of a media clip in the chronological sequence.

In one embodiment, the method comprises the step of
a. allocating a media clip Start Event to the start timecode of each media clip in each media track.

In one embodiment, the method comprises the step of
a. allocating a media clip End Event to the end timecode of each media clip in each media track.

In one embodiment, the method comprises the step of
a. determining the chronological sequence of the Start Events and the End Events.

In one embodiment, the method comprises the step of
a. logging the chronological sequence of each of the Start Events and the End Events.

In one embodiment, the method comprises the step of
a. allocating an initial group identifier.

In one embodiment, the group identifier is a number.

In one embodiment, the method comprises the step of
a. separating at least one or more media clip into grouped media clips according to the timeframe of the determined series of groups.

In one embodiment, the method comprises the step of
a. allocating the grouped media clips to a group in a digital file.

In one embodiment, the method comprises the step of
a. receiving at least one or more audio tracks associated with a received video track, each track comprising one or more audio clips.

In one embodiment, the method comprises the step of
a. separating at least one or more audio clip into grouped audio clips according to the timeframe of the determined series of groups.

In one embodiment, the method comprises the step of
a. allocating the grouped audio clips to a group in a digital file.

In one embodiment, the method comprises the step of
a. receiving at least one or more external audio tracks comprising external audio clips not recorded in association with a video track; and
b. separating the at least one or more external audio clips into grouped external audio clips according to the timeframe of the determined series of groups.

In one embodiment, the method comprises the step of
a. allocating the grouped external audio clips to a group in a digital file.

According to another aspect of the present invention, a media track organizing system is provided for organizing media tracks that have been previously recorded, the media track organizing system comprising:
a. a receiver configured for receiving information relating to audio and visual tracks;
b. a transmitter configured for transmitting information relating to audio and visual tracks;
c. a processor configured for operating according to digital instructions;
d. computer readable storage medium configured for storing instructions for:
   i. receiving information indicative of a plurality of media tracks, each media track comprising one or more media clips, each media clip extending over a given time range, the media tracks extending over a total time range; and
   ii. processing a series of chronologically consecutive time increments in said time range by, for each time increment, carrying out the steps of:
      1. actuating a toggle setting if an end of a media clip falls within the time increment,
      2. determining whether the toggle setting has been actuated from a review of a previous time increment;
      3. allocating a new group identifier if the start of a media clip falls within the time increment and the toggle setting is actuated, and
      4. resetting the toggle setting if a new group identifier has been allocated.

In one embodiment, the computer readable storage medium is configured for storing instructions for
a. allocating an initial group identifier.

In one embodiment, the group identifier is a number.

In one embodiment, the computer readable storage medium is configured for storing instructions for
a. selecting a time increment.

In one embodiment, the computer readable storage medium is configured for storing instructions for
a. selecting a time increment equal to the time increments between frames in the media clips.

In one embodiment, the computer readable storage medium is configured for storing instructions for
a. allocating a media clip Start Event to the start of each media clip in each media track.

In one embodiment, the computer readable storage medium is configured for storing instructions for
a. allocating a media clip End Event to the end of each media clip in each media track.

In one embodiment, the computer readable storage medium is configured for storing instructions for
a. determining the chronological sequence of the Start Events and the End Events.

In one embodiment, the computer readable storage medium is configured for storing instructions for
a. logging the chronological sequence of each of the Start Events and the End Events.

In one embodiment, the computer readable storage medium is configured for storing instructions for
a. determining a series of groups from the allocated group identifiers

In one embodiment, the computer readable storage medium is configured for storing instructions for
a. determining the time ranges of each of the series of groups.

In one embodiment, the computer readable storage medium is configured for storing instructions for
a. separating at least one or more media clip into grouped media clips according to the timeframe of the determined series of groups.

In one embodiment, the computer readable storage medium is configured for storing instructions for
a. allocating the grouped media clips to a group in a digital file.

In one embodiment, the computer readable storage medium is configured for storing instructions for
a. receiving at least one or more audio tracks associated with a received video track, each track comprising one or more audio clips.

In one embodiment, the computer readable storage medium is configured for storing instructions for
a. separating at least one or more audio clip into grouped audio clips according to the timeframe of the determined series of groups.

In one embodiment, the computer readable storage medium is configured for storing instructions for
a. allocating the grouped audio clips to a group in a digital file.

In one embodiment, the computer readable storage medium is configured for storing instructions for
a. receiving at least one or more external audio tracks comprising external audio clips not recorded in association with a video track; and
b. separating the at least one or more external audio clips into grouped external audio clips according to the timeframe of the determined series of groups.

In one embodiment, the computer readable storage medium is configured for storing instructions for
a. allocating the grouped external audio clips to a group in a digital file.

According to a further aspect of the present invention, a method of organizing media tracks on an electronic device is provided, the method of organizing media tracks comprising the steps of
a. receiving information indicative of a plurality of media tracks, each media track comprising one or more clips, each clip extending over a given time range, the media tracks extending over a total time range; and
b. processing a series of chronologically consecutive time increments in that time range by, for each time increment, carrying out the steps of:
   i. actuating a toggle setting if an end of a clip falls within the time increment,
   ii. determining whether the toggle setting has been actuated from a review of a previous media clip
   iii. allocating a new group identifier if the start of a clip falls within the time increment and the toggle setting is actuated, and
   iv. resetting the toggle setting if a new group identifier has been allocated.

In one embodiment, the method comprises the step of
a. allocating an initial group identifier.

In one embodiment, the group identifier is a number.

In one embodiment, the method comprises the step of
a. selecting a time increment.

In one embodiment, the method comprises the step of
a. selecting a time increment equal to the time increments between frames in the clips.

In one embodiment, the method comprises the step of
a. allocating a media clip Start Event to the start of each media clip in each media track.

In one embodiment, the method comprises the step of
a. determining the chronological sequence of the Start Events and the End Events.

In one embodiment, the method comprises the step of
a. logging the chronological sequence of each of the Start Events and the End Events.

In one embodiment, the method comprises the step of
a. determining a series of groups from the allocated group identifiers

In one embodiment, the method comprises the step of
a. determining the time ranges of each of the series of groups.

In one embodiment, the method comprises the step of
a. separating at least one or more media clip into grouped media clips according to the timeframe of the determined series of groups.

In one embodiment, the method comprises the step of
a. allocating the grouped media clips to a group in a digital file.

In one embodiment, the method comprises the step of
a. receiving at least one or more audio tracks associated with a video track, each audio track comprising one or more audio clips.

In one embodiment, the method comprises the step of
a. separating at least one or more audio clip into grouped audio clips according to the timeframe of the determined series of groups.

In one embodiment, the method comprises the step of
a. allocating the grouped audio clips to a group in a digital file.

In one embodiment, the method comprises the step of
a. receiving at least one or more external audio tracks comprising external audio clips not recorded in association with a video track; and
b. separating the at least one or more external audio clips into grouped external audio clips according to the timeframe of the determined series of groups.

In one embodiment, the method comprises the step of
a. allocating the grouped external audio clips to a group in a digital file.

In one embodiment, at least one media track comprises a video track.

In one embodiment, one or more selected from the receiver, the transmitter, the processor and the computer readable storage medium are part of one or more selected from a web server or client computing device.

It should be noted that the web server, client computing device and the computer readable storage medium provide the same or similar advantages as the advantages provided by the corresponding computer implemented method, some of which are described herein. Additionally the web server and/or client computing device provides the advantage of deployment across a computer network, such as the Internet, providing distribution, access and economy of scale advantages. Furthermore, the computer readable storage medium provides further advantages, such allowing the deployment of computer instructions for installation and execution by one or more computing devices.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a schematic layout of a series of seven tracks T1-T7 in chronological order along a timeline;

FIG. 2 shows a flow chart of a first embodiment of a method of organizing tracks on an electronic device;

FIG. 3 shows a flow chart of a second embodiment of a method of organizing tracks on an electronic device;

FIG. 4 shows a schematic diagram showing a first embodiment of a track organizing system;

FIG. 5 shows a schematic diagram of a second embodiment of a track organizing system; and

FIGS. 6-11 show a flow chart of a third embodiment of a method of organizing tracks.

### DETAILED DESCRIPTION

It should be noted in the following description that like or the same reference numerals in different embodiments denote the same or similar features.

It is anticipated that the methods and processes for organizing media tracks and/or clips described below will be capable of being carried out on a system for organizing media tracks as embodied by either a system of computing devices 100 as described in more detail below, or a computing device 200 as described in further detail below, or any combination thereof.

### System of Computing Devices 100

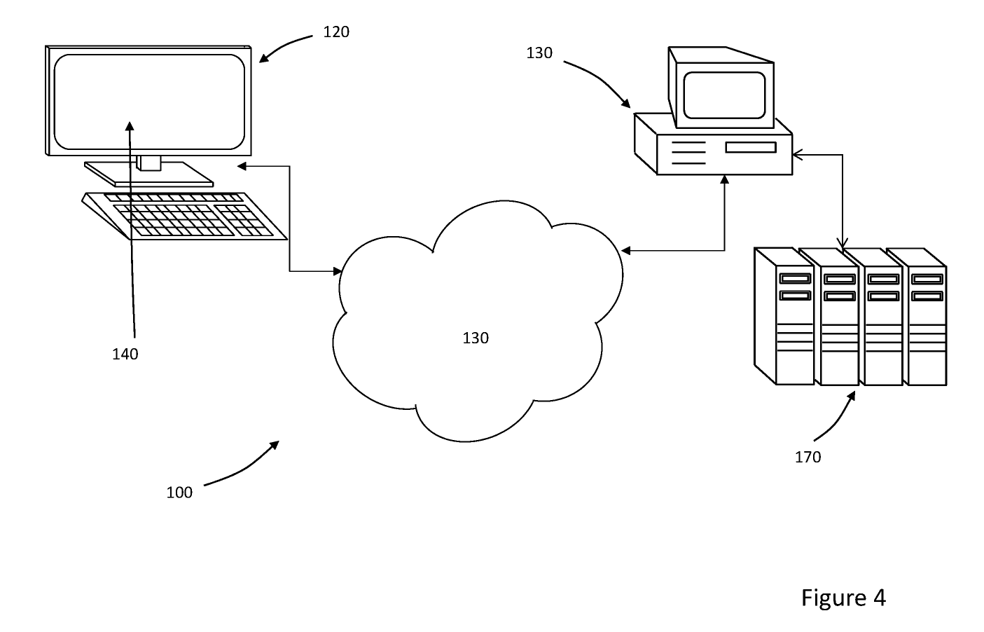

FIG. 4 shows a system 100 of computing devices adapted for organizing media tracks over a network such as the Internet, preferably by means of a web server 110.

As such, the system 100 comprises a server 110 for serving web pages to one or more client computing devices 120 over the Internet 130. It should be noted that in addition to carrying out the software instructions as described, it is envisaged that the server 110 can also be adapted for performing both the functions of traditional e-commerce processing and the allocation of e-commerce credit to a user account in return for the provision of the functionality is provided by the software as a service. In this manner, a user may interact with the server 110 to purchase services available for purchase.

In a preferred embodiment, the server 110 is a web server configured to provide a web server application for receiving requests, such as Hypertext Transfer Protocol (HTTP) and File Transfer Protocol (FTP) requests, and serving hypertext web pages or files in response. The web server application can be, for example the Apache™ or the Microsoft™ IIS HTTP server.

The server 110 is also provided with a hypertext preprocessor for processing one or more web page templates and data from one or more databases 170 to generate hypertext web pages. The hypertext preprocessor may, for example, be the PHP: Hypertext Preprocessor (PHP) or Microsoft Asp™ hypertext preprocessor. The web server 110 is also provided with web page templates, such as one or more PHP or ASP files.

Upon receiving a request from the web server application 140, the hypertext preprocessor is operable to retrieve a web page template, from the web page templates, execute any dynamic content therein, including updating or loading information from the one or more databases 170, to compose a hypertext web page. The composed hypertext web page can comprise client side code, such as Javascript, for Document Object Model (DOM) manipulating, asynchronous HTTP requests and the like.

The database 170 is adapted for storing user account data representing one or more user accounts for users. Such user account data is created by the server 110 during a user registration process.

Client computing devices 120 are provided with a browser application, such as the Chrome™, Mozilla Firefox™ or Microsoft Internet Explorer™ browser applications. The browser application requests hypertext web pages from the web server 110 and renders the hypertext web pages on a display device 140.

### Computing Device 200

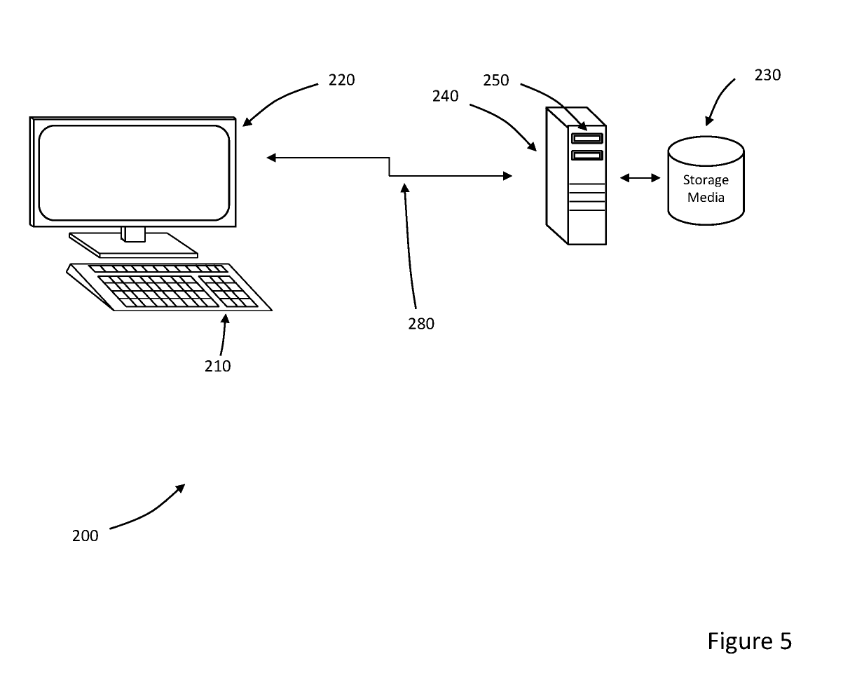

FIG. 5 shows a computing device 200. In a preferred embodiment, the computing device 200 takes the functionality of a server 110 as described above to function as a system. In this manner, the computing device 200 is adapted to comprise functionality for communication with the Internet 130, storage capability (such as the database 170) for storing user account data, software, media track data and the like.

However, it should be noted that the computing device 200 may be adapted for use as the client computing devices 120 is also shown in FIG. 5. In this manner, the computing device may comprise differing technical integers, such as the display device 2020, human interface 260 and the like. In other words, the technical integers of the computing device 200 is shown in FIG. 5 are exemplary only and variations, adaptations and the like may be made thereto within the purposive scope of the embodiments described herein and having regard for the particular application of the computing device 200.

In particular the steps of the method for e-commerce credit to a user account, as described in further detail below, may be implemented as computer program code instructions executable by the computing device 200. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 200 comprises semiconductor memory (not shown) comprising volatile memory such as random access memory (RAM) or read only memory (ROM). The memory may comprise either RAM or ROM or a combination of RAM and ROM.

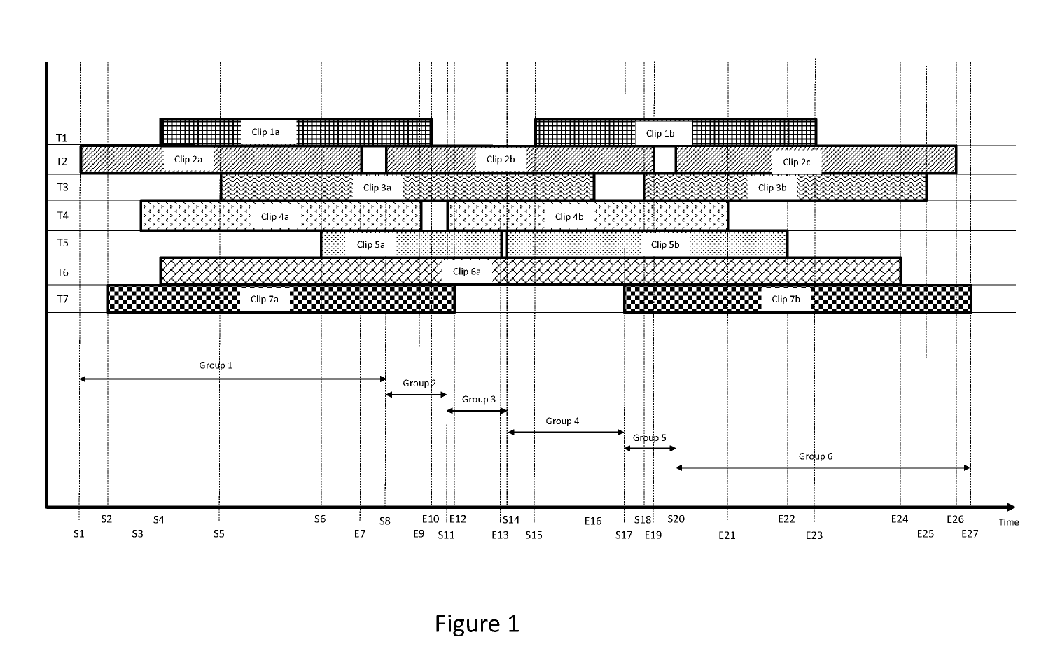

The device 200 comprises a computer program code storage medium reader 250 for reading the computer program code instructions from computer program code storage media. The storage media may be optical media such as CD-ROM disks, magnetic media such as floppy disks and tape cassettes or flash media such as USB memory sticks. It is envisaged that pre-recorded tracks, which can include several clips in each track as shown in FIG. 1, can be read from such computer program code storage media by the computer program code storage medium reader 250.

The device further comprises I/O interface (not shown) for communicating with one or more peripheral devices. The I/O interface may offer both serial and parallel interface connectivity. For example, the I/O interface may comprise a Small Computer System Interface (SCSI), Universal Serial Bus (USB) or similar I/O interface for interfacing with the storage medium reader 250. The I/O interface may also communicate with one or more human input devices (HID) 260 such as keyboards, pointing devices, joysticks and the like. The I/O interface may also comprise a computer to computer interface (not shown), such as a Recommended Standard 232 (RS-232) interface, for interfacing the device 200 with one or more personal computer (PC) devices. The I/O interface may also comprise an audio interface (not shown) for communicate audio signals to one or more audio devices, such as a speaker or a buzzer.

The device 200 also comprises a network interface (not shown) for communicating with one or more computer networks 280. The network 280 may be a wired network, such as a wired Ethernet™ network or a wireless network, such as a Bluetooth™ network or IEEE 802.11 network. The network 280 may be a local area network (LAN), such as a home or office computer network, or a wide area network (WAN), such as the Internet or private WAN.

The device 200 comprises an arithmetic logic unit or processor 240 for performing the computer program code instructions. The processor 240 may be a reduced instruction set computer (RISC) or complex instruction set computer (CISC) processor or the like. The device 200 further comprises a storage device 230, such as a magnetic disk hard drive or a solid state disk drive.

Computer program code instructions may be loaded into the storage device 230 from the storage media using the storage medium reader 250 or from the network 280 using the network interface. During the bootstrap phase, an operating system and one or more software applications are loaded from the storage device 230 into the memory. During the fetch-decode-execute cycle, the processor 240 fetches computer program code instructions from the memory, decodes the instructions into machine code, executes the instructions and stores one or more intermediate results in memory.

In this manner, the instructions stored in the memory, when retrieved and executed by the processor 240, may configure the computing device 200 as a special-purpose machine that may perform the functions described herein.

The device 200 also comprises a video interface 220 for conveying video signals to a display device 220, such as a liquid crystal display (LCD), cathode-ray tube (CRT), light emitting diode (LED) or similar display device.

The device 200 also comprises a communication bus subsystem for interconnecting the various devices described above. The bus subsystem may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

### Method of Operation

Several possible methods of operation of the device 200 or system 100 will now be described below with reference to steps that are carried out. Any steps carried out should be regarded as being carried out by the processor on instruction from software stored on digital media, such as may be found in the server 110, databases 170, computer program code storage medium reader 250 and storage device 230, unless stated otherwise.

It is envisaged that pre-recorded data indicative of media tracks, and preferably video tracks will initially be received by the device 200 or system 100, preferably as an advanced authoring format (“AAF”) file. It is envisaged that the AAF file could for example be received by transfer from a flash disk memory, or over a network.

Each video track will comprise one or more video clips, with each video clip extending over a given time range. It is envisaged that certain media clips can also be formatted as “Grouped Clips”, having several media tracks associated with each Grouped Clip.

From these clips, a series of groups will be determined, together with an associated time frame for each group. Each of these groups will be defined by a series of video clips, together extending over a group master time frame. In each of these groups, at least part of the timeframe of each video clip in that group overlaps at least part of the timeframe of every other video clip in that group by at least one frame.

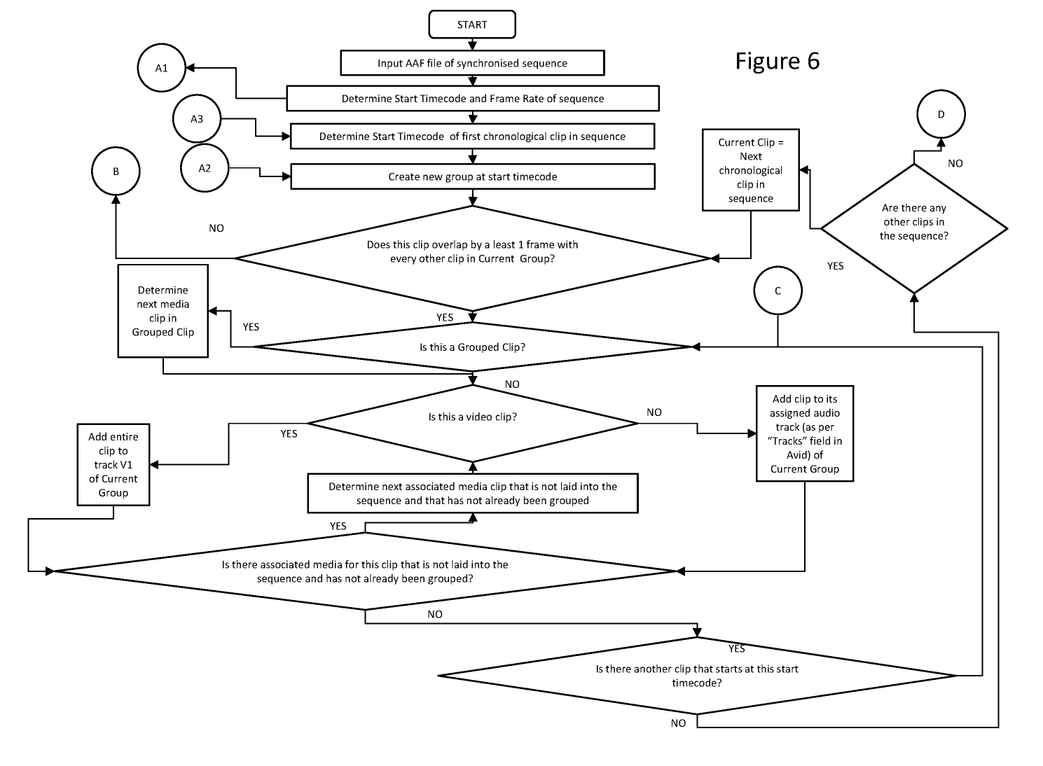

FIGS. 6-10 relates to series of operational steps described as part of a first operational methodology, and any flowchart references to numerals within a circle shown in these figures should be interpreted as moving between these figures.

For the purpose of convenience, the time range over which a media clip or group extends will be referred to as a “timecode range”, while the specific time at which a clip or group starts will be referred to as a “start timecode”, and the specific time at which a clip or group ends will be referred to as an “end timecode”. In the film and television industries, the term “timecode” is used to reference a specific moment in a recorded stream's media.

As may be seen in FIG. 6, preferably an advanced authoring format file

(“AAF”) will initially be input into the system, the AAF file including a synchronized sequence of tracks as exemplified in FIG. 1 by reference numerals T1-T7. Each track is associated with one or more media clips, for example track T1 is shown in FIG. 1 as being associated with Clip 1a and Clip 1b, track T2 being associated with clip 2a, Clip 2b, Clip 2c, etc. Each media clip can be an audio clip, a video clip or a grouped clip.

Initially, the start timecode and frame rate of the synchronized sequence is determined.

Details of the first chronological clip in the synchronized sequence will be retrieved, and the start timecode of this clip determined. This clip will become the current clip, or clip that is currently being processed. The timecode that is used can be an absolute timecode indicative of the actual time at which the media clips were taken in a particular time zone, or it can be a relative timecode used as a means to index the timeframe of the clips against each other.

Once the clips have been organized into their final output, they will be ordered relative to a “master” timecode for the synchronized sequence output that sets out the relative time frame and ordering of the media clips. The master timecode of the groups need not be the same as the relative or absolute timecode of the media clips. It is envisaged that the master time code for the groups could be the same time code as the timecodes of the clips, or could even be an absolute timecode (for example the actual time that the clips were taken in a particular time zone), but need not be.

Similarly, each clip is assessed as whether it must be assigned to the current group. And groups that have already had clips assigned to them and to which no further clips are being assigned, are referred to as former groups.

It will be appreciated by person skilled in the art that that logging, storing and/or saving of any determined variable, timecode range, timeframe clip allocation or group allocation can happen at any stage during this process for retrieval and use in a later part of the process. In this specification, the term “log” is used to refer to the storage or saving of information, and associated terms such as “logging” or “logged” should be interpreted accordingly.

The first determination of the system is to establish whether the timecode range or range of time over which the current clip extends, overlaps all of the other clips that were previously allocated to the current group. This could, for example, be accomplished by comparing the time ranges of previously assigned clips in that group to the timecode range or time range of the current clip.

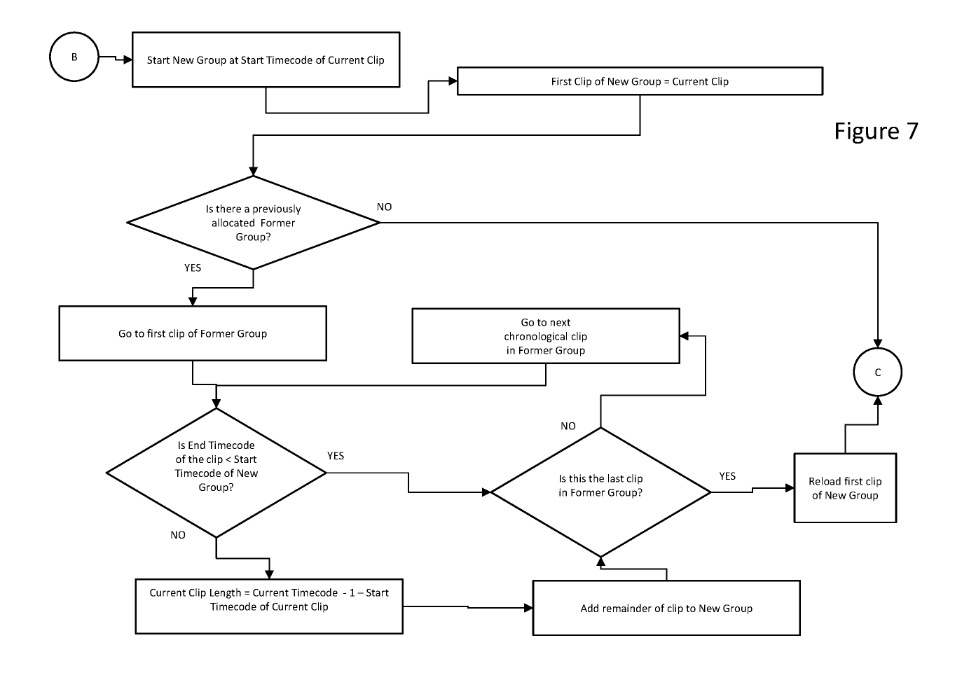

As the first clip would automatically only overlap with itself, this would be true, this would trigger the determination that a New Group had started (the first group). This is shown by the reference to the circle B in FIG. 6, which is replicated in FIG. 7, and starts a sequence that determines the start of a new group.

Continuing with FIG. 7, the start timecode of the New Group would be set to the start timecode of the current clip. The system at this stage would test for any Former Groups that have been allocated previous to the current New Group. Since no groups have been previously determined or allocated, the system would loop back to checking for the next clip in sequence via reference numeral C in FIG. 7, which is shown in FIG. 6. In this way, the process cycles through each consecutive clip to determine its Start Timecode and whether or not the clip is part of a new group.

Where a new group is started and a previously allocated group exists, the process acts to establish whether the timecode range or time range of any clips assigned to former groups extends past the start timecode for the new group. If so, these clips are divided into separate clips, with the division occurring at the start timecode of the New Group.

Those portions of the clips belonging to the former group that extended past the start timecode of the new group are allocated as separate clips to the new group.

If the current clip is determined to be overlapping every other clip in the current group by at least its start timecode, then no new group is established, as shown in FIG. 6. Instead, a determination is then made as to whether the current clip is a grouped clip. A grouped clip is a timeframe containing two or more media clips associated with each other, for example where several cameras and their microphones have recorded media relating to the same scene at the same time.

If the current clip is a grouped clip, then the first of the media clips in the grouped clip is set as the current clip, and each of the subsequent media clips in the grouped clip is assessed in order in a looping process.

Each media clip, whether being part of a grouped clip or not, is then checked to determine whether it is a video clip or not. If it is a video clip, then the entire clip is added to track V1 as part of the current group.

Video clips are processed with a view to adding or allocating an assessed portion of it to an output video track “V1”, which is similar in nature to a grouped clip, in that the video track typically comprises more than one (but can also only contain one) video clips, each associated with a group that they have been allocated to.

Once the video clip has been added to output video track V1, the process checks for media associated with the video clip that has not yet been laid into the sequence, and that has not already been grouped. Such associated media could, for example be an audio track that was recorded by the same video camera, and which correlates closely to the video (for example in terms of lip movement of actors, et cetera)

If there is such associated media, then this associated media clip is determined and similarly tested for whether or not it is a video clip.

If the current clip being allocated is not a video clip (i.e. is an audio clip), then the audio clip is added to it's assigned audio track, and preferably the audio track assigned by the assistant editor in the pre-editing phase (called A1 for ease of reference) as part of the current group. It will be appreciated that in some media feeds, none of the media clips will be video clips. In such a case, while audioclips will not have overlapping “frames”, the audio clips will be processed in the same way that the video clips are processed to thereby divide the media files into groups that have an overlap of time ranges.

Audio track A1 is similar to output video track V1, similar in nature to a grouped clip, but comprising only audio clips.

After this, the audio clip is similarly check for associated media that has not been laid into the sequence and has not already been grouped.

If there is no associated media for the audio or video clip, then the process checks for any other clips that start at the same start timecode. This step will retrieve all of the other media clips in a grouped clip.

If there are no other media clips that start at the same start timecode, then the process checks for whether there are any other media clips in the synchronized sequence. If there are, then the next clip in the synchronized sequence is set as the current clip, and the cycle starts again.

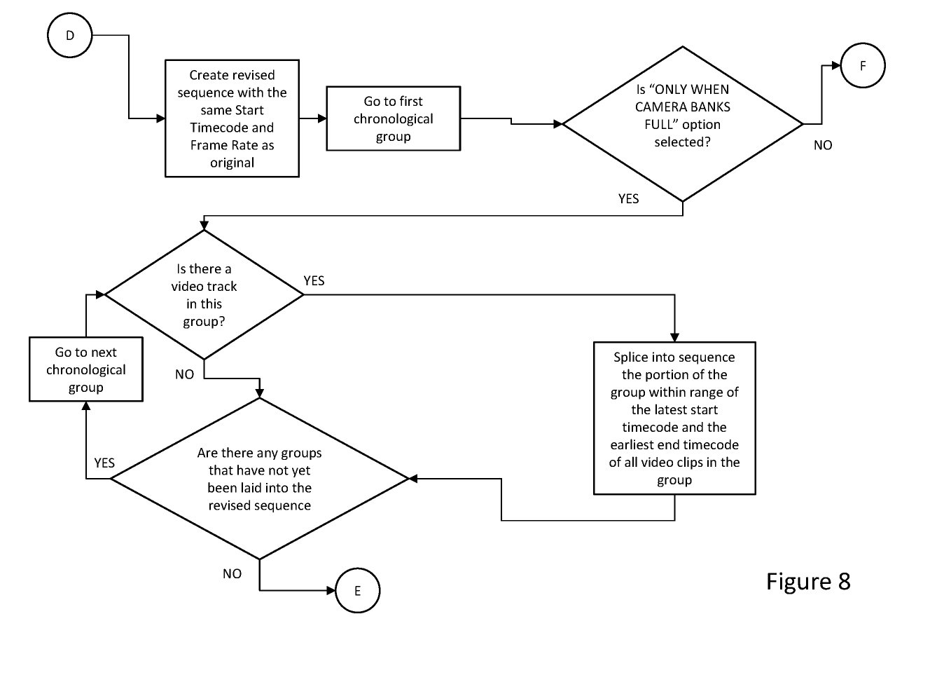

If there are no further media clips in the synchronized sequence to be allocated to groups, then the process moves on, via reference numeral E in a circle, to the process shown in FIG. 8.

Once all of the clips have been allocated to groups, then the process starts creating a revised sequence with the same start timecode and frame rate as the original synchronized sequence. Once the revised sequence has been created, the first chronological group is initially selected. This first chronological group is set as the current group to be processed.

It is envisaged that the software instructions will allow for an option called “ONLY WHEN CAMERA BANKS FULL” to be selected. This option is used to indicate that the user of the system only wants groups to be provided with clips in it where video is available from all of the cameras at the same time. In some instances, users of the system will select this option as it allows for more convenient editing.

If this option is selected, then the current group is checked to establish whether there is a video track in the group.

If there is, then only those portions of the clips in the group that fit between the latest start timecode and the earliest end timecode of the video clips within the group are spliced into the revised sequence.

If this option is selected, then the process will chronologically check for any further groups that have not yet been laid into the revised sequence. These groups will be subjected to the steps, until no further groups are left that have not been laid into the revised sequence.

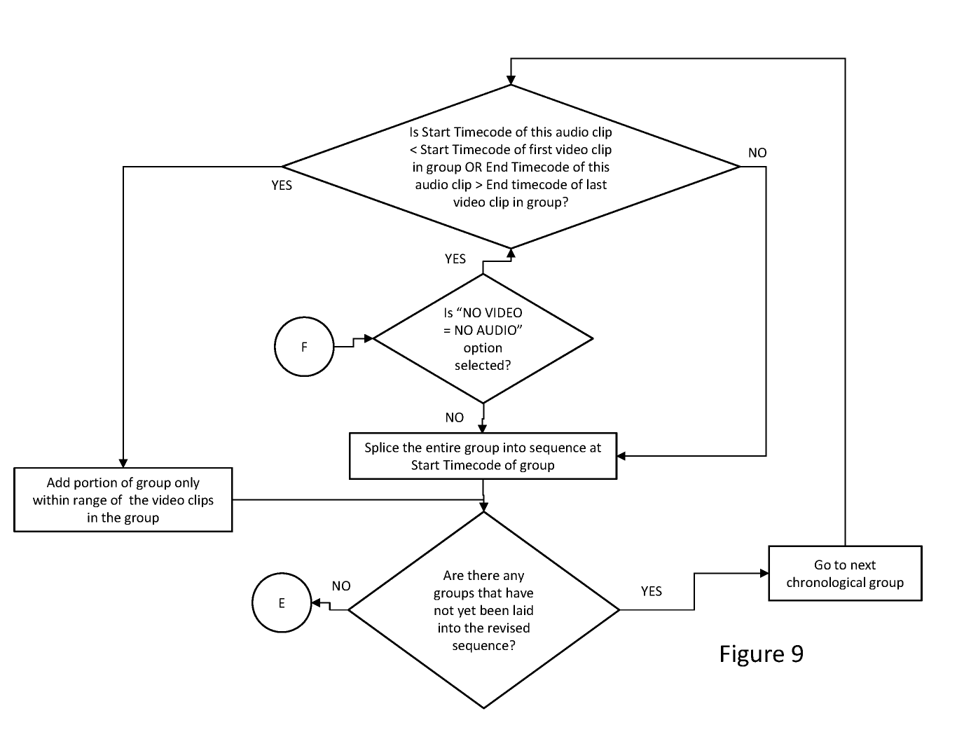

If the “ONLY WHEN CAMERA BANKS FULL” option is not selected, then the process moves through F in a circle shown in FIG. 8, to the same reference shown in FIG. 9.

Starting from reference numeral F shown in FIG. 9, the process then checks whether the “NO VIDEO=NO AUDIO” option is selected.

The “NO VIDEO=NO AUDIO” option may be selected by users of the system to ensure that the output file does not include media where audio clips are not supported by video over the same timecode range.

If this option is not selected, then the clips from the entire group will be spliced into sequence from the master start timecode of the group, and the process will check for any further groups that have not yet been laid into the revised sequence.

If “the NO VIDEO=NO AUDIO” option is selected, then the timeframes of any audio clips that extend further or earlier than the timeframes of the video clips in that group are cropped. This is determined by checking whether the start timecode of each audio clip starts earlier than the earliest start timecode of the video clips in the group, or whether the end timecode of each audio clip end later than the latest end timecode of the last video clip in the group.

If no audio clips extend earlier than the earliest start timecode or later than the latest end timecode of the video clips in that group, then the entire group is spliced into sequence at the start timecode of the group.

However, if one audio clip does extend earlier than the earliest start timecode or later than the latest end timecode of the video clips in that group, then only the portion of the group that is within the range of the video clips of the group are added to the revised sequence. Similarly, if an audio clip does not have an associated video clip, and therefore does not overlap any portion of a video clip, then the audio clip will be deleted.

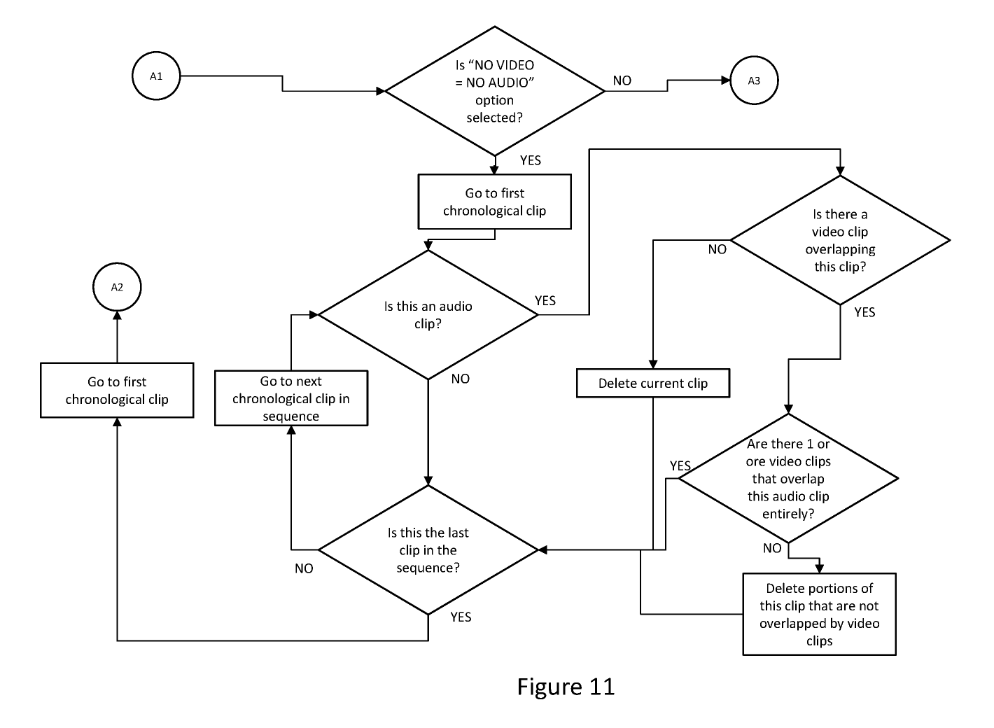

It is envisaged that the process selected by the “NO VIDEO=NO AUDIO” option could also be carried out at the very start of the process immediately after the AAF file has been received and the start timecode has been determined. In this way, all audio files can immediately be trimmed down to the same length as their associated video files. This process is shown in FIG. 11, following from reference numeral A1 on FIG. 6. After initially receiving the input AAF files of the synchronized sequence, the system would determine the start timecode and frame rate of the sequence. The system then tests to see if the “NO VIDEO=NO AUDIO” option is selected.

If the option is not selected then no trimming of audio files is required, and the 6 the system will determine the start timecode of the first chronological clip in the sequence and cycle through each of the audio and video clips in order to allocate them to various groups as described as shown in FIG. 6, following on from reference numeral A3 on FIG. 11.

If the “NO VIDEO=NO AUDIO” option is selected, then the first chronological clip will be assessed to see if it is an audio clip. If it is not an audio clip then it will be tested to see if it is the last clip in the sequence. If it is not the last clip in the sequence then the process will start assessing the next chronological clip in the sequence to see if it is an audio clip. If it is the last clip in sequence, this means that all of the clips in sequence have been assessed for whether or not they have associated audio and have been cropped or trimmed accordingly. The system will then go back to the first chronological clip, which will then be processed according to the process shown in FIG. 6 starting from reference numeral A2.

If the clip being assessed is an audio clip then the system will test to see if there is a video clip overlapping the audio clip. If there is no video clip that overlaps the audio clip, then the audio clip will be deleted. If there is a video clip that overlaps the audio clip, then the system will test to see if there is a collective of video clips (i.e. one or more video clips) that overlap the audio clip entirely. If there are, then the system will move to the next clip in the sequence. If the audio clip is not completely overlapped by one or more video clips, then those portions of the audio clip that are not overlapped by video clips will be trimmed or cropped from the audio clip. In this way, each media clip in the sequence will be assessed and trimmed for having a relevant video associated with an audio clip. After this, assessment of the groupings can begin as shown in FIG. 6. Naturally, after having trimmed the audio files according to whether the “NO VIDEO=NO AUDIO” option is selected, it will no longer be necessary to trim them again as shown in FIG. 9.

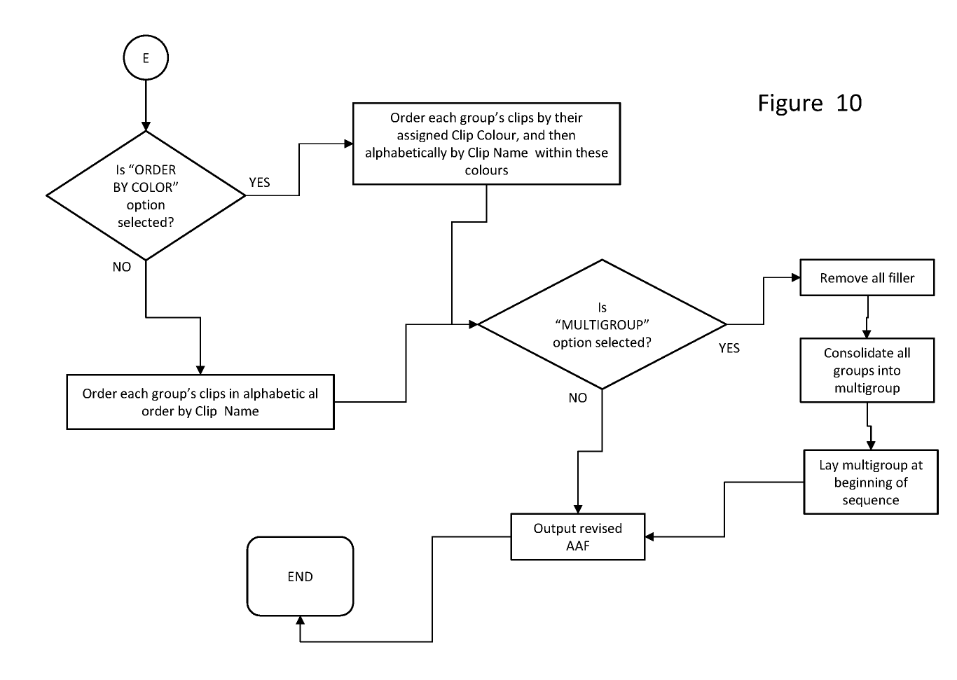

Once all of the groups have been processed with consideration to the options selected and spliced into the revised sequence accordingly , the process extends via reference numeral E in a circle in FIG. 9 to the similar reference numeral E in FIG. 10.

The process then checks for whether an option “ORDER BY COLOUR” is selected. This is an option that may be selected by users of the system that allows for the organization of the various clips in the groups according to a predetermined preference, ranking or weighting. One example of such a predetermined preference may be the subjective quality of the clip. For example, each clip would have been previously classified as being of a particular quality by users according to, for example, subjective levels of entertainment value, lighting, sound quality, video quality, or the like. In the industry, the subjective level of quality typically result in allocation of a particular “colour” to a clip. However, there may be any number of reasons as to why clips would be assigned a predetermined preference, ranking or weighting.

Where the process would ordinarily organize the clips in the various groups according to the chronological order of their start timecode, when this option is selected, the process organizes the clips in order of their allocated colours or quality as a first field, and then orders them by another field, for example by chronological order of their start timecode or alphabetically by their clip name.

The process then checks for whether a further option is selected. This option is called “MULTIGROUP”. If this option is selected, it indicates that the user of the system wants the media in the timeline formatted and delivered in a multigroup in the final output file. A multigroup is the highest hierarchical level of media organization in Avid Media Composer (in order of hierarchy level from lowest to highest it goes Clip, Group, Multigroup) and consolidates multiple groups into the one “multigroup” clip. The multigroup is spliced into the beginning of the sequence, contains the groups in their chronological order, and removes all time gaps where they exist between two groups. Accordingly, where the process detects that this option is selected, all “filler” time gaps between the groups are removed, and the start of one group is inserted immediately after the end of another group, removing any filler or time gaps between them. Whereas by default the revised AAF contains a sequence with many group clips, when this option is selected the revised AAF contains a sequence with only 1 multigroup clip. If the “MULTIGROUP” option is not selected, then the revised AAF is output as is.

It will be appreciated that where the media clips do not include any video clips, then the audio clips will be processed in the same way as the methods described (unless this is not logically possible).

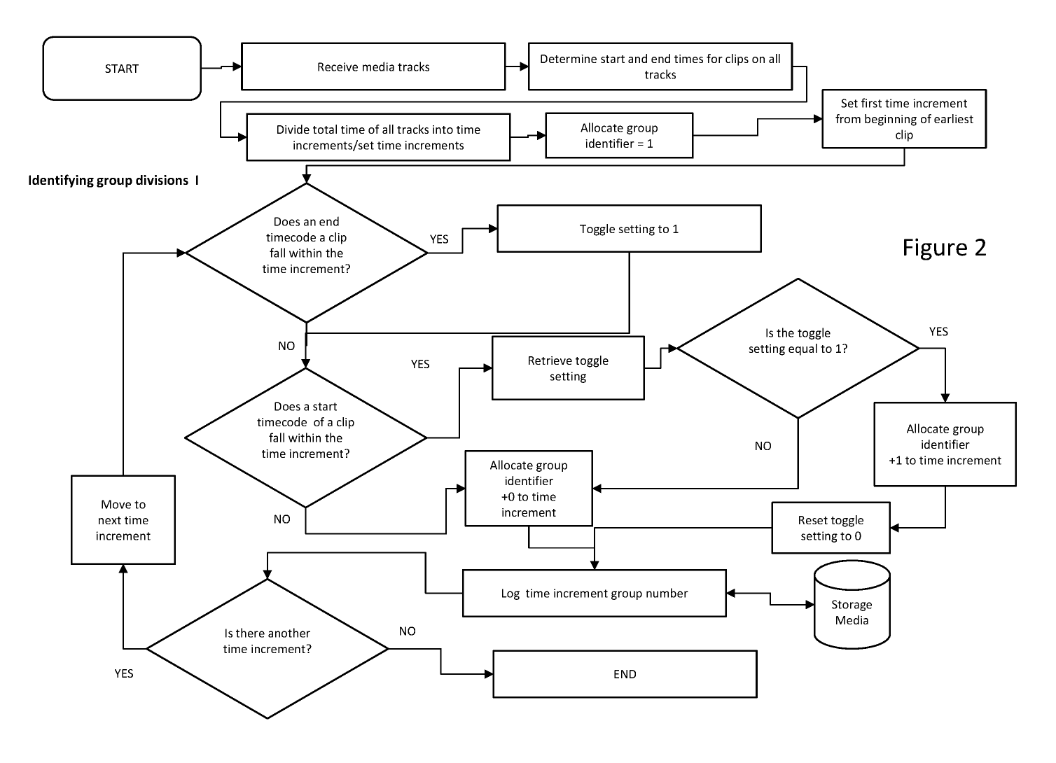

It is envisaged that the end result of identifying which groups the clips are to be laid into, could be achieved by other possible methods. Another possible embodiment of the invention is shown in FIG. 2.

As shown in FIG. 2, the process starts by receiving the various media tracks, and determining the start timecodes and end timecodes for each clip on all of the tracks. The processor shown in FIG. 2 divides the entire timeframe of all of the media tracks into time increments, and assesses each time increment to be able to allocate a group identifier to it.

The process then divides the total time of all the tracks (i.e. from the earliest start timecode to the latest end timecode) into time increments. Preferably the time increments are equal to the time increment of one frame, and preferably each time increment is configured to match the actual frames of the video clips.

An initial group identifier is allocated for the first time increment, and the first time increment is set to start from the earliest start timecode.

The process then tests for whether an end timecode of a clip falls within the time increment. If this is true, then a toggle setting is set to 1. If this is not true then the process tests for whether the start timecode of a clip falls within the time increment. If this is true, then the toggle setting is retrieved. If the toggle setting is equal to 1, then a new group identifier is allocated to that time increment, and the toggle is then reset to 0. Preferably, the new group identifier is equal to the previous group identifier plus 1.

If the toggle setting is not equal to 1, then the group identifier is not changed for that time increment.

Similarly, if a start timecode of a clip does not fall within that time increment, then the group identifier is not changed for that time increment. The group identifier for that time increment is then logged, and the process then checks if there is another time increment.

In this way, each time increment is tested and evaluated using the process described above. Once all of the time increments have been tested, the various groups will be reflected by the sets of group identifiers of the time increments, and each groups start timecode and end timecode can be determined.

After this, all of the clips, including grouped clips, can be divided and/or separated according to the start timecode and end timecode of the groups, and cropped and/or ordered according to the processes described above with reference to FIGS. 6-10.

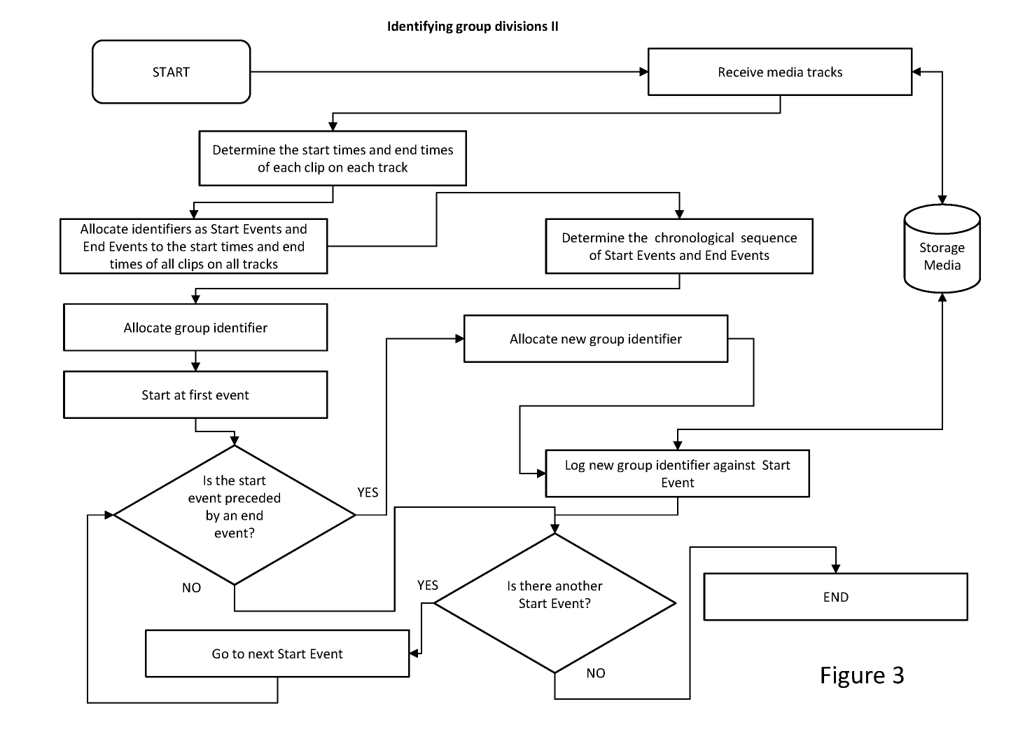

Another possible embodiment of a method for determining, and/or allocating groups to the various media clips or portions thereof is shown in FIG. 3.

The process shown in FIG. 3 recognizes that a new group number will be allocated every time a pattern is recognised, the pattern being that a start timecode of a media clip is immediately preceded by an end timecode of another media clip.

The process allocates identifiers as start events and end events to the start timecode and end timecode of all clips on all of the media tracks, respectively. The process determines the chronological sequence of all of the start events and end events, and logs these.

The process then starts off allocating an initial group identifier, and starts assessment of the first start event. The process then enters a looped sequence that moves to each subsequent start event in their chronological order, testing each start event as described below.

The process first checks to see if the start event is preceded by an end event. If this is the case, then a new group identifier is allocated to that start event, and the new group identifier is logged against that start event. The process then determines if there is another start event. If there is then it goes to the next start event and repeats the loop. Similarly, if the start event is not preceded by an end event, then the system checks to see if there is another start event after current one, and if there is then it moves to that one.

If there are no further start events, then the start timecodes and end timecode of the various group identifiers are identified setting the group timecode ranges or time frames.

Once the various groups have been identified, then the clips, including grouped clips, can be divided and/or separated according to the start timecode and end timecode is of the groups, and further edited according to the processes described above with reference to FIGS. 6-10, and preferably an advanced authoring format (AAF) digital file is output (although the output of alternative digital files are envisaged). The digital file is preferably transmitted over a network to a user.

It will be appreciated that the digital file that is output at the end of the processes need not necessarily be an AAF-type file, but could be in the form of any digital file that provides the required metadata to be able to group media and media clips using the methods outlined above. Examples of alternative file types could include file types such as extensible markup language (XML) or open media framework (OMF) files, or similar media files that may be used in the future.

It will also be appreciated that the output digital file could be transmitted for display on a display screen, or could be transmitted over a network, such as the Internet, for receipt by a user.

It is further envisaged that the process and system can be used for processing live feeds, for example from live television shows. For the processing of live feeds, the synchronized sequence is synchronized to an absolute timecode called a “locked timecode”, which may for example be the actual time in a particular time zone. For such a series of live feeds, each being a media track, the determination of the chronological sequence of the start of each media clip in each media track and an end of each media clip in each media track system would simply be determined from the actual chronological sequence of the locked timecode. In this way the system and process would be able to allocate a new group identifier to the chronological time span from the start of a new media clip of a live feed if the start of a new media clip in a media track is immediately preceded by an end of a media clip in the locked chronological sequence, to thereby determine a series of groups.

Such automated processing of live feeds would allow for more organized and quicker editing of the series of media clips, to thereby facilitate the provision of meaningfully edited “live” shows that are closer in time to the actual live feed.

### Interpretation

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

The terminology used herein is for the purpose of describing particular embodiments only and is not intended to be limiting of the invention. As used herein, the singular articles “a”, “an” and “the” are intended to include the plural forms as well, unless the context clearly indicates otherwise and thus are used herein to refer to one or to more than one (i.e. to at least one“) of the grammatical object of the article. By way of example, the phrase an element” refers to one element or more than one element.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” only “one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In Accordance with:

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Database:

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi , XML or the like.

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analyzing” or the like, refer to the action and/or processes of a computer or computing system, or similar electronic computing device, that manipulate and/or transform data represented as physical, such as electronic, quantities into other data similarly represented as physical quantities. References to “the process” should be construed as reference to steps being carried out by such electronic computing devices (including the processor of such devices).

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

The media track organization system and method therefore described herein, and/or shown in the drawings, are presented by way of example only and are not limiting as to the scope of the invention. Unless otherwise specifically stated, individual aspects and components of the media track organization system may be modified, or may have been substituted therefore known equivalents, or as yet unknown substitutes such as may be developed in the future or such as may be found to be acceptable substitutes in the future. The media track organization system and method therefore may also be modified for a variety of applications while remaining within the scope and spirit of the claimed invention, since the range of potential applications is great, and since it is intended that the present invention be adaptable to many such variations.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### Chronological Order

For the purpose of this specification, where method steps are described in sequence, the sequence does not necessarily mean that the steps are to be carried out in chronological order in that sequence, unless there is no other logical manner of interpreting the sequence.

### Markush Groups

In addition, where features or aspects of the invention are described in terms of Markush groups, those skilled in the art will recognize that the invention is also thereby described in terms of any individual member or subgroup of members of the Markush group.

### INDUSTRIAL APPLICABILITY

It is apparent from the above, that the arrangements described are applicable to the audio and video media editing industries.

What is claimed is:

1) A media track organizing system for organizing media tracks that have been previously recorded, the track organizing system comprising
a) computer readable storage medium configured for storing instructions for
i) receiving information indicative of a plurality of media tracks, each media track comprising one or more media clips, each media clip extending over a given time range;
ii) determining a series of groups from the plurality of media tracks, wherein each group is defined by a series of media clips extending over a timeframe, wherein at least part of the timeframe of each media clip in that group overlaps at least part of the timeframe of every other media clip in that group by at least one frame.

2) The media track organizing system as claimed in claim 1), wherein the computer readable storage medium is configured for storing instructions for
a) separating at least one or more video clip into grouped video clips according to the timeframe of the determined series of groups.

3) The media track organizing system as claimed in claim 2), wherein the computer readable storage medium is configured for storing instructions for
a) allocating the grouped video clips to a group in a digital file.

4) The media track organizing system as claimed in claim 1), wherein the computer readable storage medium is configured for storing instructions for
a) receiving at least one or more audio tracks associated with a received video track, each track comprising one or more audio clips.

5) The media track organizing system as claimed in claim 4), wherein the computer readable storage medium is configured for storing instructions for
a) separating at least one or more audio clip into grouped audio clips according to the timeframe of the determined series of groups.

6) The media track organizing system as claimed in claim 5), wherein the computer readable storage medium is configured for storing instructions for
a) allocating the grouped audio clips to a group in a digital file.

7) The media track organizing system as claimed in claim 1), wherein the computer readable storage medium is configured for storing instructions for
a) receiving at least one or more external audio tracks comprising external audio clips not recorded in association with a video clip; and
b) separating the at least one or more external audio clips into grouped external audio clips according to the timeframe of the determined series of groups.

8) The media track organizing system as claimed in claim 7), wherein the computer readable storage medium is configured for storing instructions for
a) allocating the grouped external audio clips to a group in a digital file.

9) The media track organizing system as claimed in claim 1), wherein the computer readable storage medium is configured for storing instructions for
a) allocating a group identifier as a current group.

10) The media track organizing system as claimed in claim 9), wherein the computer readable storage medium is configured for storing instructions for
a) determining whether the start timecode of a media clip overlaps by at least one frame with every other media clip in the current group.

11) The media track organizing system as claimed in claim 10), wherein the computer readable storage medium is configured for storing instructions for
a) creating a new group based on the determination of whether the start timecode of a media clip overlaps by at least one frame with every other media clip in the current group.

12) The media track organizing system as claimed in claim 11), wherein the computer readable storage medium is configured for storing instructions for
a) allocating portions of media clips to groups based on whether the time range of the media clips overlaps the start timecode of the new group.

13) A method of organizing media tracks on an electronic device, the method of organizing media tracks comprising the steps of
i) receiving information indicative of a plurality of media tracks, each track comprising one or more media clips, each media clip extending over a given time range;
ii) determining a series of groups from the plurality of media, wherein each group is defined by a series of media clips extending over a timeframe, wherein at least part of the timeframe of each media clip in that group overlaps at least part of the timeframe of every other media clip in that group by at least one frame.

14) The method of organizing media tracks as claimed in claim 13), wherein the method comprises the step of
a) separating at least one or more video clip into grouped video clips according to the timeframe of the determined series of groups.

15) The method of organizing media tracks as claimed in claim 14), wherein the method comprises the step of
a) allocating the grouped video clips to a group in a digital file.

16) The method of organizing media tracks as claimed in claim 13), wherein the method comprises the step of
a) receiving at least one or more audio tracks associated with a received video track, each track comprising one or more audio clips.

17) The method of organizing media tracks as claimed in claim 16), wherein the method comprises the step of
a) separating at least one or more audio clip into grouped audio clips according to the timeframe of the determined series of groups.

18) The method of organizing media tracks as claimed in claim 17), wherein the method comprises the step of
a) allocating the grouped audio clips to a group in a digital file.

19) The method of organizing media tracks as claimed in claim 13), wherein the method comprises the step of
a) receiving at least one or more external audio tracks comprising external audio clips not recorded in association with a video track; and
b) separating the at least one or more external audio clips into grouped external audio clips according to the timeframe of the determined series of groups.

20) The method of organizing media tracks as claimed in claim 19), wherein the method comprises the step of
a) allocating the grouped external audio clips to a group in a digital file.

21) The method of organizing media tracks as claimed in claim 13), wherein the method comprises the step of
a) allocating a group identifier as a current group.

22) The method of organizing media tracks as claimed in claim 21), wherein the method comprises the step of
a) determining whether the start timecode of a media clip overlaps by at least one frame with every other media clip in the current group.

23) The method of organizing media tracks as claimed in claim 13), wherein the method comprises the step of
a) creating a new group based on the determination of whether the start timecode of a media clip overlaps by at least one frame with every other media clip in the current group.

24) The method of organizing media tracks as claimed in claim 23), wherein the method comprises the step of
a) allocating portions of media clips to groups based on whether the time range of the media clips overlaps the start timecode of the new group.

25) The method of organizing media tracks as claimed in claim 13), wherein the method comprises the step of
a) receiving an instruction to crop media clips in an allocated group to limit their time range between the latest start timecode of any video clip in the group and the earliest end timecode of any video clip in the group.

26) The method of organizing media tracks as claimed in claim 25), wherein the method comprises the step of
a) cropping media clips in an allocated group to limit their time range between the latest start timecode of any video clip in the group and the earliest end timecode of any video clip in the group.

27) The method of organizing media tracks as claimed in claim 13), wherein the method comprises the step of
a) receiving an instruction to crop audio clips in an allocated group to limit their time range between the earliest start timecode of any video clip in the group and the latest end timecode of any video clip in the group.

28) The method of organizing media tracks as claimed in claim 27), wherein the method comprises the step of
a) cropping audio clips in an allocated group to limit their time range between the earliest start timecode of any video clip in the group and the latest end timecode of any video clip in the group.

29) A media track organizing system for organizing media tracks that have been previously recorded, the track organizing system comprising
a) a receiver configured for receiving information relating to audio and visual tracks;
b) a transmitter configured for transmitting information relating to audio and visual tracks;
c) a processor configured for operating according to digital instructions;
d) computer readable storage medium configured for storing instructions for:
i) receiving information indicative of a plurality of media tracks, each track comprising one or more media clips;
ii) determining the chronological sequence of a start of each media clip in each media track and an end of each media clip in each media track;
iii) allocating a new group identifier to the chronological time span from the start of the new media clip if the start of a new media clip in a media track is immediately preceded by an end of a media clip in the chronological sequence, to thereby determine a series of groups.

30) A method of organizing media tracks on an electronic device, the method of organizing media tracks comprising the steps of
i) receiving information indicative of a plurality of media tracks, each track comprising one or more media clips;
ii) determining the chronological sequence of a start of each media clip in each media track and an end of each media clip in each media track;
iii) allocating a new group identifier to the chronological time span from the start of the new media clip if the start of a new media clip in a video track is immediately preceded by an end of a media clip in the chronological sequence, to thereby determine a series of groups.

31) A media track organizing system for organizing media tracks that have been previously recorded, the media track organizing system comprising:
a) a receiver configured for receiving information relating to audio and visual tracks;
b) a transmitter configured for transmitting information relating to audio and visual tracks;
c) a processor configured for operating according to digital instructions;
d) computer readable storage medium configured for storing instructions for:
i) receiving information indicative of a plurality of media tracks, each media track comprising one or more media clips, each media clip extending over a given time range, the media tracks extending over a total time range; and
ii) processing a series of chronologically consecutive time increments in said time range by, for each time increment, carrying out the steps of:
(1) actuating a toggle setting if an end of a media clip falls within the time increment,
(2) determining whether the toggle setting has been actuated from a review of a previous time increment;
(3) allocating a new group identifier if the start of a media clip falls within the time increment and the toggle setting is actuated, and
(4) resetting the toggle setting if a new group identifier has been allocated.

32) A method of organizing media tracks on an electronic device, the method of organizing media tracks comprising the steps of
a) receiving information indicative of a plurality of video tracks, each video track comprising one or more clips, each clip extending over a given time range, the video tracks extending over a total time range; and
b) processing a series of chronologically consecutive time increments in that time range by, for each time increment, carrying out the steps of:
i) actuating a toggle setting if an end of a video clip falls within the time increment,
ii) determining whether the toggle setting has been actuated from a review of a previous video clip
iii) allocating a new group identifier if the start of a video clip falls within the time increment and the toggle setting is actuated, and
iv) resetting the toggle setting if a new group identifier has been allocated.
